(19) United States
(12) Patent Application Publication
(10) Pub. No.: US 2017/0003829 A1
(43) Pub. Date: Jan. 5, 2017

(54) GRAPHICAL USER INTERFACE FACILITATING SHARING AND COLLABORATIVE EDITING OF ELECTRONIC DOCUMENTS

(71) Applicant: MICROSOFT TECHNOLOGY LICENSING, LLC, Redmond, WA (US)

(72) Inventors: Benjamin Wilde, Quincy, MA (US); Jade Kessler, Cambridge, MA (US); Manoj Sharma, Winchester, MA (US); Ryan Shaffer, Cambridge, MA (US); Juliana Cherston, Cambridge, MA (US)

(21) Appl. No.: 14/788,757

(22) Filed: Jun. 30, 2015

(51) Int. Cl. G06F 3/0481; H04L 29/08

(52) U.S. Cl. CPC G06F 3/0481; H04L 67/1097; H04L 67/06

(57) ABSTRACT

An end user application running on a computer, for the purpose of collaborative modification of shared electronic documents, is configured to provide a graphical user interface that facilitates interactively and collaboratively modifying an electronic document. This graphical user interface includes a graphical element that conveys to an end user both sharing status information and editing status information for the currently accessed electronic document. The graphical element can take any of a number of different forms, such that each different form represents a different combination of the current sharing state and current co-authoring state of the currently accessed electronic document. Through input devices of the end user computer, an end user can manipulate this graphical element. In response to certain manipulations of the graphical element, the end user computer is configured to present further detailed information about such status and to receive further inputs from a user to change such status.

### BACKGROUND

The availability of shared storage systems for electronic documents has increased the ability of computer end users to share and collaborate in the creation of a variety of electronic documents. End users can cause documents to be stored in shared storage systems on a computer network, such as the internet. End users can instruct such a shared storage system to allow electronic documents to be shared with other end users of the shared storage system. A shared storage system generally has an access control component in a file system that tracks the access rights users have for each electronic document.

After an electronic document has been shared with two or more end users, the shared storage system manages access to the shared electronic document to ensure consistency of the electronic document, especially in the case of collaborative modifications to the electronic document. A kind of collaboration system, typically resident on a server computer that is configured to access the file system of the shared storage system, typically is involved in managing this collaborative modification by tracking which users currently are accessing an electronic document.

### SUMMARY

This Summary is provided to introduce a selection of concepts in a simplified form that are further described below in the Detailed Description. This Summary is intended neither to identify key or essential features, nor to limit the scope, of the claimed subject matter.

An end user application running on a computer, for the purpose of collaborative modification of shared electronic documents, is configured to provide a graphical user interface that facilitates interactively and collaboratively modifying an electronic document. This graphical user interface includes a graphical element that conveys to an end user both sharing status information and editing status information for the currently accessed electronic document. The graphical element can take any of a number of different forms, such that each different form represents a different combination of the current sharing state and current co-authoring state of the currently accessed electronic document. Through input devices of the end user computer, an end user can manipulate this graphical element. In response to certain manipulations of the graphical element, the end user computer is configured to present further detailed information about such status and to receive further inputs from a user to change such status.

To generate such a graphical element, an application uses an identifier of the electronic document being edited, such as a file name, to access information from a shared storage system and from a collaboration system. The shared storage system provides information from its access control data for the electronic document, indicative of a number of end users with whom the electronic document is shared. The collaboration system provides information about end users that are currently accessing the electronic document. The application generates the graphical element by combining an icon, an indication of the number of users sharing the document and an indication of the number of users currently editing the document.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example computer system configured to share electronic documents among users.

FIG. 2 an example graphical user interface for an application configured to enable a user to share an electronic document with another user.

FIG. 3 is a block diagram of an example implementation of generating a graphical user interface element.

FIG. 4 is a flow chart describing operation of an example implementation of generating a graphical user interface element.

FIGS. 5A-5E are example graphical user interface elements for an application.

FIG. 6 is a block diagram of an example computer in which components of such a system can be implemented.

### DETAILED DESCRIPTION

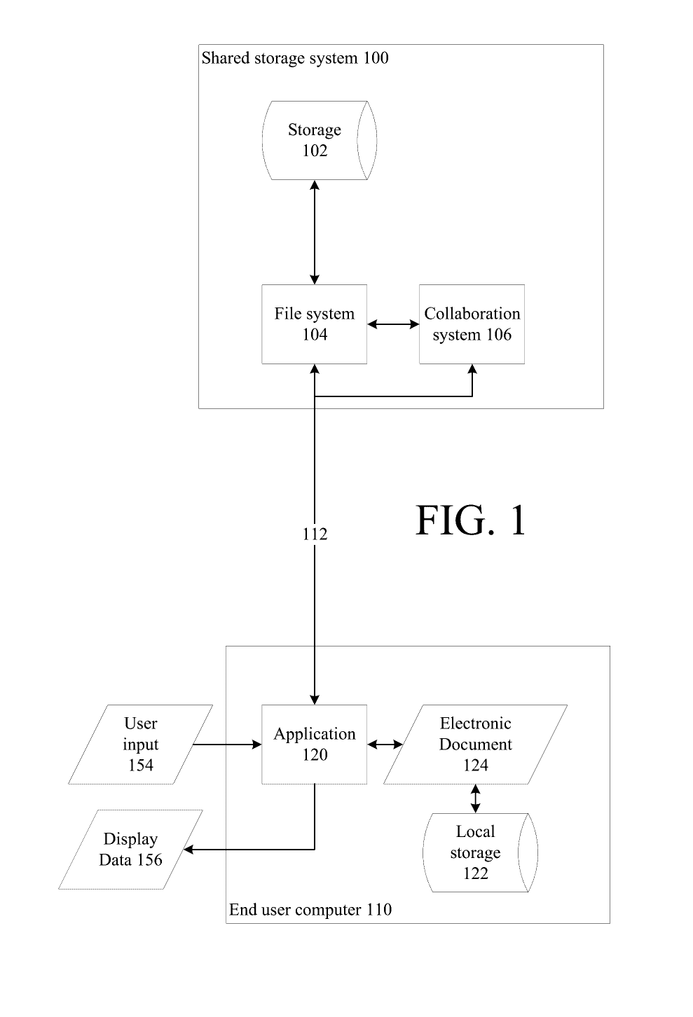

FIG. 1 is a block diagram of an example computer system configured to support sharing and collaborative modification of electronic documents by multiple end users using multiple end user computers.

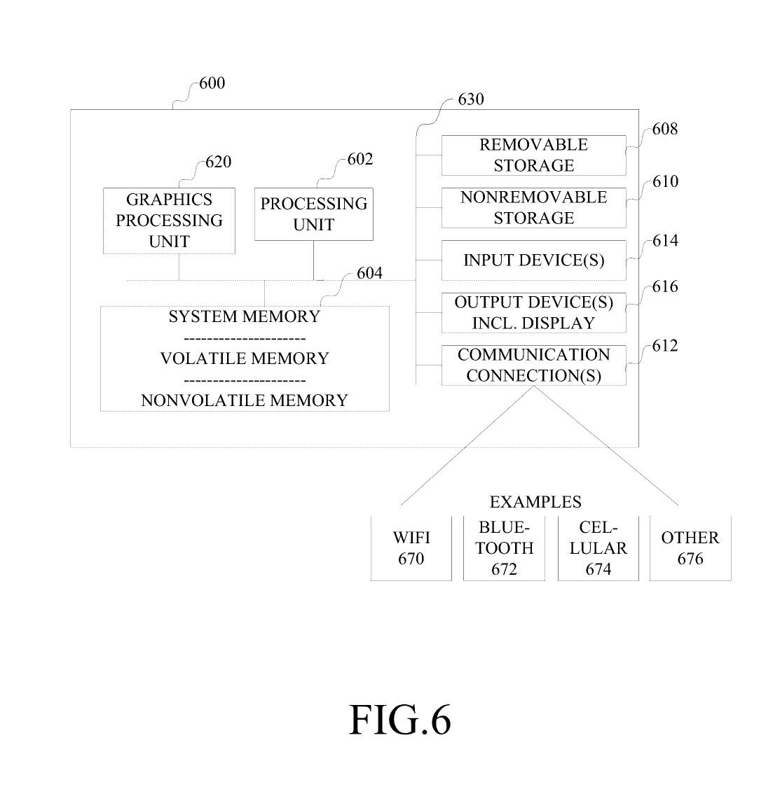

A computer system that is configured to support sharing and collaborative modification of electronic documents by multiple end users includes a shared storage system 100. The shared storage system 100 generally includes storage 102 in which data is stored in data files accessible through a file system 104 that is part of the shared storage system. The file system configures a server computer to maintain information about each file stored in storage 102. The shared storage system 100 can be implemented using one or more general purpose computers, such as described in connection with FIG. 6, and configured to implement a server computer that is responsive to requests over a computer network to access, through the file system, files on the storage 102.

Multiple end user computers 110 are connected to the shared storage system for communication over a computer network 112, such as the internet. An end user computer 110 can be a computer such as described in connection with FIG. 6 and configured as an end user computer running one or more applications 120. Examples of such a computer include, but are not limited to, a tablet computer, a slate computer, a notebook computer, a desktop computer, a virtual desktop computer hosted on a server computer, a handheld computer, and a mobile phone including a computer and applications. The computer network 112 can be any computer network supporting interaction between the end user computers and the shared storage system, such as a local area network or a wide area network, whether private and/or publicly accessible, and can include wired and/or wireless connectivity. The computer network can be implemented using any of a number of available network communication protocols, including but not limited to Ethernet and TCP/IP.

An end user computer 110 includes one or more applications 120. An application is a computer program executed on the end user computer that configures the computer to be responsive to user input 154 to allow an end user to interactively modify an electronic document 124. An electronic document can include any kind of data, such as text, still images, video and audio. The application processes the electronic document, in response to user input through input devices, by selecting and combining portions of data to create the content of the electronic document, by displaying or otherwise presenting display data 156, such as a graphical user interface including the content the electronic document, through output devices (not shown) to the end user, and by storing the electronic document in memory and/or in a data file in storage of the end user computer.

A variety of kinds of applications can be used on an end user computer. Examples of an application include, but are not limited to, a word processing application, a presentation application, a note taking application, a text editing application, a paint application, an image editing application, a spreadsheet application, a desktop publishing application, a drawing application, a video editing application, and an audio editing application.

An application generates an electronic document that is stored in a data file. Such a data file can be stored in local storage 122 and/or the shared storage system 100. The electronic document, while being modified by an end user on the end user computer, also is temporarily stored in memory on the end user computer.

If an electronic document is stored in a data file in the shared storage system 100, the file system 104 of the shared storage system includes information indicating a sharing state of the electronic document. Such information can be in the form of access controls indicating which end users are authorized to access the electronic document. The file system also can be configured to be responsive to a query to provide this information to another application, such as application 120 on an end user computer. An end user can view and modify the sharing state of an electronic document in a number of ways.

If an electronic document is stored in a data file in the shared storage system 100, and the data file is shared, with modification rights, with at least one more end user, then two or more end user computers may access and attempt to modify the electronic document. To handle such a condition, the shared storage system can include a kind of collaboration system 106. The collaboration system 106 is a computer program that configures the server computer to manage access to shared electronic documents in the shared storage system 100.

The collaboration system 106 is configured to store information about end users that are currently accessing the electronic document. The collaboration system can be configured to be responsive to a query to provide this information to another application on an end user computer, such as application 120.

Using the information about end users currently accessing an electronic document, the collaboration system can implement any of a number of different techniques for coordinating access to the electronic document to ensure consistency of the electronic document. For example, the collaboration system can prevent one user from writing to the data file for the electronic document while another user has the data file open for writing. As another example, the collaboration system can interactively merge changes to the electronic document as such changes are being made collaboratively by multiple users. In such a case, the collaboration system merges changes received from end user computers in memory local to the collaboration system, and then transmits a modified version of the electronic document to each end user computer with an application currently accessing the document.

Having now described the computer system in which an application on an end user computer can be used to interactively modify a shared electronic document, more details of the application will now be described.

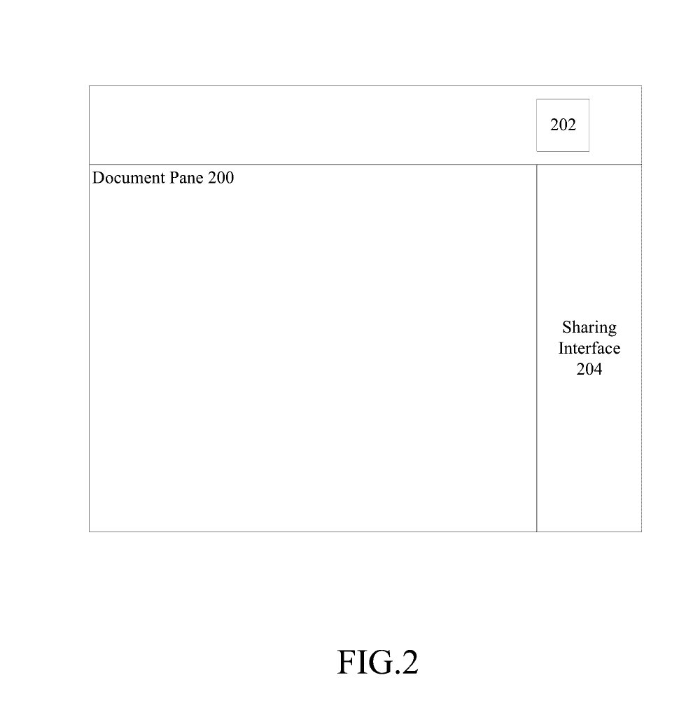

In FIG. 2, an example graphical user interface for the application is shown. In this example graphical user interface, a document pane 200 is a primary display area in which the electronic document is presented on a display. The end user computer receives user inputs through input devices, and can associate such inputs with operations with respect to the electronic document in document pane 200, or with respect to other graphical elements in the graphical user interface. The end user computer processes some user inputs to effect modifications to the electronic document currently being accessed in the document pane 200.

The graphical user interface for the application in FIG. 2 also includes a graphical element 202 that conveys to the user both sharing status information and editing status information for the electronic document being edited. Through input devices of the end user computer, an end user can manipulate this graphical element to instruct the end user computer to present further detailed information about such status and to change such status. For example, the application can display, in response to manipulation of this graphical element, another pane as part of the graphical user interface to present more detailed information about such status, to change such status and to allow interact.

As shown in FIG. 2, as an example, the graphical user interface can include a sharing pane 204 in which the application can present information about the sharing status and the current use of the currently accessed electronic document, and through which such information can be modified. Through this pane, an example of which is described in co-pending application, entitled “Graphical User Interface Facilitating Uploading of Electronic Documents to Shared Storage”, filed on even date herewith, by Jade Kessler et al., which is hereby incorporated by reference, the sharing and co-authoring status of an application can be displayed.

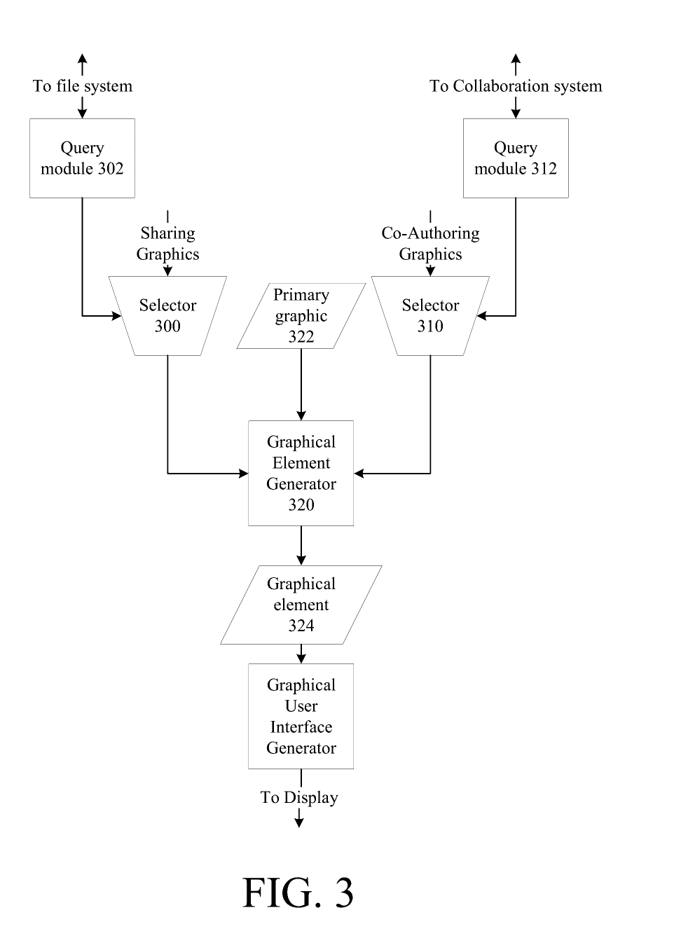

To generate such a graphical element 202, an application uses an identifier of the electronic document being edited, such as a file name, to access information both from the shared storage system 100 and from the collaboration system 106. The shared storage system provides information from its access control data for the electronic document, indicative of a number of end users with whom the electronic document is shared. The collaboration system provides information about end users that are currently accessing the electronic document. The application generates the graphical element 202 by combining an icon, an indication of the number of users sharing the document and an indication of the number of users currently editing the document. An example implementation of the generation of this graphical element is described in more detail below in connection with FIGS. 3 to 5A-5E.

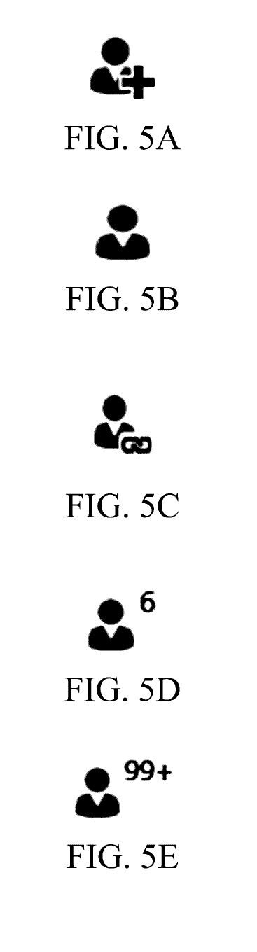

FIG. 3 illustrates an example implementation of computer logic for generating such a graphical element as shown in FIGS. 2 and 5A-5E. Such computer logic can be implemented using computer program instructions to configure a computer.

In FIG. 3, a first selector 300 is configured to select from among graphics indicating a sharing state of an electronic document. For example, a sharing state can be “private”, “public” or “limited”. A query module 302 is configured to request sharing state from the shared storage system, and, based on this sharing state, control the selection made by the selector 300.

Similarly, a second selector 310 is configured to select from among graphics indicating a co-authoring state of an electronic document. For example, a co-authoring state can be no co-authors, a number X less than a threshold Y of co-authors, and a number Z over the threshold Y of co-authors. A query module 312 is configured to request the co-authoring state from the collaboration system, and, based on this co-authoring state, control the selection made by the selector 310.

A graphical element generator 320 has inputs configured to receive the outputs of selectors 300 and 310, and a primary graphic 322, such as an icon, and an output configured to provide the graphical element 324 that combines the icon, indication of shared status and indication of co-authoring status. The graphical element 324 is an input to a graphical user interface generator 322 which provides the graphical user interface of the application.

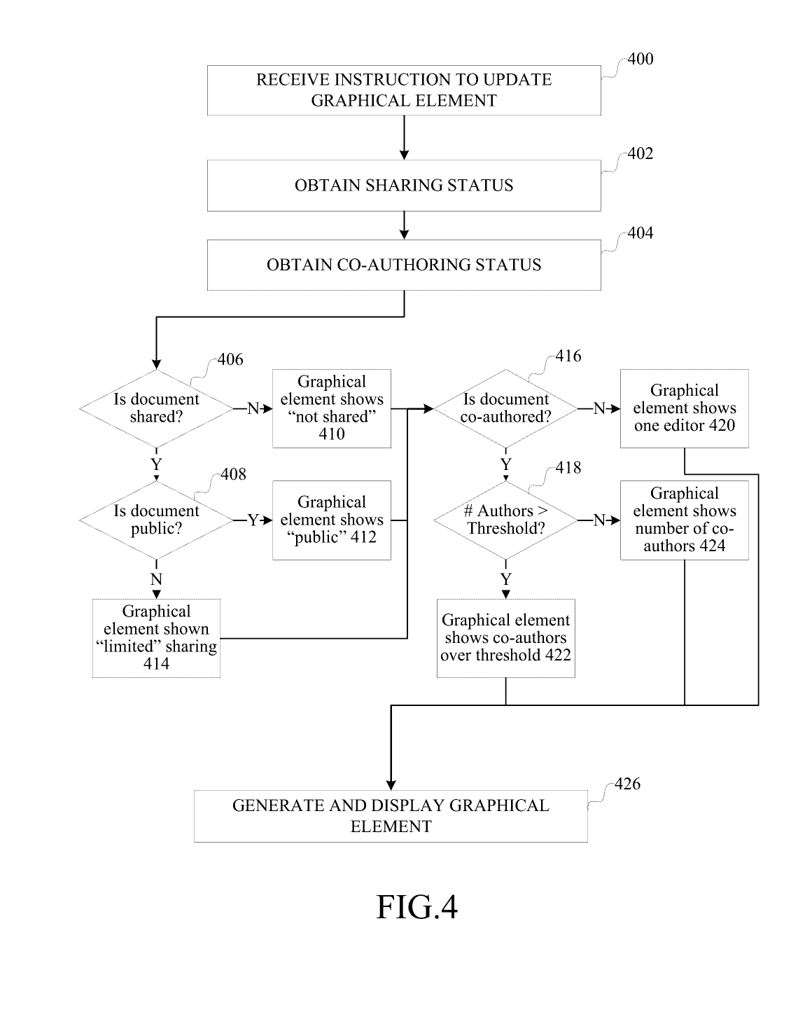

A flowchart of operation of an example implementation of a graphical element generator, in an application which configures the computer to generate a graphical element, will now be described in connection with FIG. 4. Computer program instructions can be used to configure the computer to implement operation such as shown in FIG. 4.

In FIG. 4, a graphical element generator receives 400 an instruction to create or update the graphical element for sharing. Such an instruction can be received in several ways. For example, an application may periodically poll the collaboration system and/or shared storage system for updated information. As another example, the application may periodically receive a current state of such information from the collaboration system and/or the shared storage system. As another example, certain operations of the application, such as a change in the electronic document being displayed or accessed, may invoke a refresh operation to update the graphical element. As another example, the application may receive notifications from the collaboration system and/or the shared storage system when changes occur.

In response to receiving the instruction to update the graphical element, the graphical element generator obtains 402 sharing information from the shared storage system and obtains 404 co-authoring information from the collaboration system. From this information, the application can generate the graphical element and then display the generated graphical element.

In the example implementation of FIG. 4, the graphical element generator determines 406 if the document has been shared. If the document has not been shared, then the graphical element is configured 410 to indicate the document is not shared. If the document has been made public, such as by publication of a link to the document, as determined at 408, then the graphical element is configured 412 to indicate the document is public. Otherwise, the document is shared with only designated people, and the graphical element is configured 414 to indicate the document has limited sharing.

Similarly, the graphical element generator determines 416 if the document is currently being edited by more than one end user. If the document is not being edited by more than one user, then the graphical element is configured 420 to indicate the document is being edited by only the current end user. The graphical element generator determines 418 if the number of co-authors is greater than a threshold. Any threshold can be used, and an example is 99. If the number of co-authors is greater than this threshold, then the graphical element is configured 422 to indicate this information. Otherwise, the graphical element is configured 424 to indicate the number of co-authors.

The graphical element is then generated 426 and displayed in the graphical user interface for the application.

It should be understood that this example implementation in FIG. 4 is merely illustrative, and that other implementations can be made. For example, accessing and processing information related to sharing status of an electronic document can be performed in any order or relative timing with respect to accessing and processing information related to co-authoring status of an electronic document. Further, when processing either the sharing status or co-authoring status information, there are many ways to convert the status information into corresponding graphical information. Example ways include, but are not limited to, a series of comparisons, a lookup table, and conditional logic.

Additionally, the number of co-authors can be computed by the application from information provided by the collaboration system or can be provided by the collaboration system. The co-authoring information can be displayed by the application in the pane 204 or in other part of the graphical user interface. The co-authoring information also can be processed by the application or the collaboration system to eliminate remove duplicate end user information. For example, if an end user accesses the same document on two different end user computers, then the co-authoring information indicates two users are accessing the electronic document. In such a case, the application or the collaboration system can process this information as representing a single user.

Additionally, the number of states to be considered for each of the sharing status and the co-authoring status can be different in different implementations. A threshold on the number of co-authors can be omitted; alternatively, multiple thresholds can be used. The distinction between private and public sharing can be omitted.

Referring now to FIGS. 5A to 5E, some example graphical elements are shown.

In FIG. 5A, the graphical element includes a primary graphic 500 which includes an additional indicator 502 of a sharing state of an electronic document. In this example, the “+” symbol is used as the indicator 502 to indicate that the document is not currently shared, and thus other users could be added to share the electronic document. In other words, this graphical element indicates that the electronic document is not shared with anyone, or is private. Note that an electronic document that is not shared also would not have any co-authoring status.

In FIG. 5B, the graphical element includes the primary graphic 500 and no additional indicator. In this example, the absence of the indicator 502 suggests that other users have already been added, but such sharing is limited.

In FIG. 5C, the graphical element includes the primary graphic 500 and an indicator 504 that the document is publicly shared. Such sharing can occur in a shared storage system in which a user can make available a link to the document.

In FIG. 5D, the graphical element includes the primary graphic 500 and an indicator 506 that the document is currently being co-authored by a number of users. In this example, the number “6” indicates that there are six users currently co-authoring the document. Such co-authoring information is managed by the collaboration system and can indicate that each of these authors has the electronic document open for write access in their respective applications on their respective end user computers. The absence of a “+” or link symbol in this example in FIG. 5D indicates that the electronic document is shared with a limited number of other users. If the electronic document also were publicly shared, then the graphical element could also include an indicator such as shown at 504 in FIG. 5C.

In FIG. 5E, the graphical element includes the primary graphic 500 and an indicator 508 that the document is currently being co-authored by a number of users that exceeds a given threshold. In this example, the number “99” indicates the threshold and “+” indicates that the number of co-authors is over that threshold. The absence of a “+” or link symbol in this example in FIG. 5E indicates that the electronic document is shared with a limited number of other users. If the electronic document also were publicly shared, then the graphical element could also include an indicator such as shown at 504 in FIG. 5C.

It should be understood that the graphical elements shown in FIGS. 5A to 5E are merely illustrative and a graphical element can be produced in many different forms, shapes, sizes and colors. For example, different icons, characters or shapes can be used as a primary graphic to designate this graphical element as being representative of sharing and co-authoring status. Different labeling, or different modifications to the primary graphic, can be used to represent each of the states of sharing and co-authoring. For example, a number of users sharing a document can be used. Thus, the graphical element can take any of a number of forms such that each different form represents a different combination of the current sharing state and current co-authoring state of the electronic document currently being displayed through the graphical user interface of the application.

It should be understood that the foregoing description is merely an example of implementations of a computer system configured to support collaborative modification of electronic documents stored in a shared storage system.

By having an application provide a graphical user interface with a graphical element indicating both sharing and current editing status, user efficiency and productivity in collaborative modification of electronic documents is improved. Such a graphical element facilitates and consolidates access to information about both aspects of collaboration, namely sharing and co-authoring.

Accordingly, in one aspect computer comprises a processing system comprising one or more processing units and storage and a network interface. The network interface is configured to connect the computer to computer network, the computer network being connected to a shared storage system, the shared storage system comprising a file system configured to store a plurality of electronic documents and to make the plurality of electronic documents available to a plurality of users. The shared storage system further comprises a collaboration system configured to manage coauthoring of an electronic document in the file system by a plurality of end users. The storage comprises computer program code that, when executed by the processing system, configures the processing system to be comprising an application configured to process user input to modify an electronic document stored in the shared storage system. The application comprises a graphical user interface including a graphical element representing sharing status and co-authoring status of the electronic document. The application is further configured to obtain the sharing status of the electronic document from the file system and to obtain the co-authoring status of the electronic document from the collaboration system.

In another aspect, an article of manufacture comprises at least one computer storage medium and computer program instructions stored on the at least one computer storage medium which, when processed by a processing system of a computer, configures the computer to be comprising an application. The computer includes a network interface configured to connect the computer to computer network, the computer network being connected to a shared storage system. The shared storage system comprises a file system configured to store a plurality of electronic documents and to make the plurality of electronic documents available to a plurality of users. The shared storage system further comprises a collaboration system configured to manage coauthoring of an electronic document in the file system by a plurality of end users. The application is configured to process user input to modify an electronic document stored in the shared storage system. The application comprises a graphical user interface including a graphical element representing sharing status and co-authoring status of the electronic document. The application is further configured to obtain the sharing status of the electronic document from the file system and to obtain the co-authoring status of the electronic document from the collaboration system.

In another aspect, a computer-implemented process comprises accessing a shared storage system to retrieve an electronic document, the shared storage system comprising a file system configured to store a plurality of electronic documents and to make the plurality of electronic documents available to a plurality of end user computers over a computer network, the shared storage system further comprising a collaboration system configured to manage coauthoring of an electronic document in the file system by a plurality of end user computers over a computer network. Sharing status of the electronic document is received from the file system. Co-authoring status of the electronic document is received from the collaboration system. A graphical user interface is displayed with the electronic document and including a graphical element representing the sharing status and the co-authoring status of the electronic document.

In any of the foregoing aspects, the graphical element can comprises a plurality of different forms, such that each different form represents a different combination of the current sharing status and current co-authoring status of the electronic document currently being displayed through the graphical user interface of the application.

In any of the foregoing aspects, the graphical element can comprises a primary graphic, an indicator of the sharing status and an indicator of the co-authoring status. The application can be further configured to process the sharing status of the electronic document to select a graphic from among a plurality of graphics as the indicator for the sharing status. The application can be further configured to process the co-authoring status of the electronic document to select a graphic from among a plurality of graphics as the indicator for the co-authoring status.

In any of the foregoing aspects, the application can be further configured to process the co-authoring status to compute a number of end users currently accessing the electronic document, wherein the application is further configured to identify an end user accessing the electronic document from a plurality of end user computers, and, in response to identifying an end user accessing the electronic document from a plurality of end user computers, to count the end user as a single co-author.

In any of the foregoing aspects, the application can be further configured to interactively update the graphical element in the graphical user interface for the electronic document currently accessed by the application while the electronic document is accessed by the application.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

Referring to FIG. 6, an example implementation of a general purpose computer will now be described. A general purpose computer is computer hardware that is configured with computer programs providing instructions to be executed by one or more processors or other logic devices in the computer. Computer programs on a general purpose computer generally include an operating system and applications. The operating system is a computer program running on the computer that manages access to various resources of the computer by the applications and the operating system. The various resources generally include the one or more processors or logic devices, memory, storage, communication interfaces, input devices and output devices.

Examples of general purpose computers include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

FIG. 6 illustrates an example of computer hardware for a computer. An example computer 600 includes at least one processing unit 602 and memory 604. The computer can have multiple processing units 602 and multiple devices implementing the memory 604. A processing unit 602 can include one or more processing cores (not shown) that operate independently of each other. Additional co-processing units, such as graphics processing unit 620 or other logic devices, also can be present in the computer; such logic devices may be located within some of the other components of the computer and shown in FIG. 6.

The memory 604 may include volatile devices (such as dynamic random access memory (DRAM) or other random access memory device), and non-volatile devices (such as a read-only memory, flash memory, and the like) or some combination of the two. The computer 600 can include additional storage (removable and/or non-removable) including, but not limited to, magnetically-recorded or optically-recorded disks or tape. Such additional storage is illustrated in FIG. 6 by removable storage 608 and non-removable storage 610. The various components in FIG. 6 are generally interconnected by an interconnection mechanism, such as one or more buses 630.

A computer storage medium is any medium in which data can be stored in and retrieved from addressable physical storage locations by the computer. Computer storage media includes volatile and nonvolatile memory devices, and removable and non-removable storage media. Memory 604 and 606, removable storage 608 and non-removable storage 610 are all examples of computer storage media. Some examples of computer storage media are RAM, ROM, EEPROM, flash memory, processor registers, or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 600 may also include communications connection(s) 612 that allow the computer to communicate with other devices over a communication medium. Communication media transmit data, such as computer program instructions, data structures, program modules or other data, over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 612 are devices, such as a wired network interface, wireless network interface, radio frequency transceiver, e.g., Wi-Fi, cellular, long term evolution (LTE) or Bluetooth, etc., transceivers, navigation transceivers, e.g., global positioning system (GPS) or Global Navigation Satellite System (GLONASS), etc., transceivers, that interface with the communication media to transmit data over and receive data from communication media.

In a computer, example communications connections include, but are not limited to, a wireless communication interface for wireless connection to a computer network, and one or more radio transmitters for telephonic communications over cellular telephone networks, and/or. For example, a WiFi connection 672, a Bluetooth connection 674, a cellular connection 670, and other connections 676 may be present in the computer. Such connections support communication with other devices. One or more processes may be running on the computer and managed by the operating system to enable voice or data communications over such connections.

The computer 600 may have various input device(s) 614 such as a touch-based input device, pen, camera, microphone, sensors, such as accelerometers, gyroscopes, thermometers, light sensors, and the like, and so on. Output device(s) 616 such as a display, speakers, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various storage 610, communication connections 612, output devices 616 and input devices 614 can be integrated within a housing with the rest of the computer hardware, or can be connected through various input/output interface devices on the computer, in which case the reference numbers 610, 612, 614 and 616 can indicate either the interface for connection to a device or the device itself as the case may be.

Each component (which also may be called a “module” or “engine” or the like), of a computer system such as described herein, and which operates on the computer, can be implemented using the one or more processing units or logic devices of the computer and one or more computer programs processed by the computer. Generally speaking, such modules have inputs and outputs through locations in memory or processor registers from which data can be read and to which data can be written when the module is executed by the computer. A computer program includes computer-executable instructions and/or computer-interpreted instructions, such as program modules, which instructions are processed by the computer. Generally, such instructions define routines, programs, objects, components, data structures, and so on, that, when processed by the computer, instruct the computer to perform operations on data or configure the computer to implement various components or data structures.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It should be understood that the subject matter defined in the appended claims is not necessarily limited to the specific implementations described above. The specific implementations described above are disclosed as examples only.

What is claimed is:

1. A computer, comprising:
a network interface configured to connect the computer to computer network, the computer network being connected to a shared storage system, the shared storage system comprising a file system configured to store a plurality of electronic documents and to make the plurality of electronic documents available to a plurality of users, the shared storage system further comprising a collaboration system configured to manage coauthoring of an electronic document in the file system by a plurality of end users; and
a processing system comprising one or more processing units and storage, the storage comprising computer program code that, when executed by the processing system, configures the processing system to be comprising:
an application configured to process user input to modify an electronic document stored in the shared storage system, the application comprising a graphical user interface including a graphical element representing sharing status and co-authoring status of the electronic document, the application being further configured to obtain the sharing status of the electronic document from the file system and to obtain the co-authoring status of the electronic document from the collaboration system.

2. The computer of claim 1 wherein the graphical element comprises a plurality of different forms, such that each different form represents a different combination of the current sharing status and current co-authoring status of the electronic document currently being displayed through the graphical user interface of the application.

3. The computer of claim 1 wherein the graphical element comprises a primary graphic, an indicator of the sharing status and an indicator of the co-authoring status.

4. The computer of claim 3, wherein the application is further configured to process the sharing status of the electronic document to select a graphic from among a plurality of graphics as the indicator for the sharing status.

5. The computer of claim 3, wherein the application is further configured to process the co-authoring status of the electronic document to select a graphic from among a plurality of graphics as the indicator for the co-authoring status.

6. The computer of claim 1, wherein the application is further configured to process the co-authoring status to compute a number of end users currently accessing the electronic document, wherein the application is further configured to identify an end user accessing the electronic document from a plurality of end user computers, and, in response to identifying an end user accessing the electronic document from a plurality of end user computers, to count the end user as a single co-author.

7. The computer of claim 1, wherein the application is further configured to interactively update the graphical element in the graphical user interface for the electronic document currently accessed by the application while the electronic document is accessed by the application.

8. An article of manufacture comprising:
at least one computer storage medium,
computer program instructions stored on the at least one computer storage medium which, when processed by a processing system of a computer, configures the computer to be comprising:
a network interface configured to connect the computer to computer network, the computer network being connected to a shared storage system, the shared storage system comprising a file system configured to store a plurality of electronic documents and to make the plurality of electronic documents available to a plurality of users, the shared storage system further comprising a collaboration system configured to manage coauthoring of an electronic document in the file system by a plurality of end users; and
an application configured to process user input to modify an electronic document stored in the shared storage system, the application comprising a graphical user interface including a graphical element representing sharing status and co-authoring status of the electronic document, the application being further configured to obtain the sharing status of the electronic document from the file system and to obtain the co-authoring status of the electronic document from the collaboration system.

9. The article of manufacture of claim 8, wherein the graphical element comprises a plurality of different forms, such that each different form represents a different combination of the current sharing status and current co-authoring status of the electronic document currently being displayed through the graphical user interface of the application.

10. The article of manufacture of claim 8, wherein the graphical element comprises a primary graphic, an indicator of the sharing status and an indicator of the co-authoring status.

11. The article of manufacture of claim 10, wherein the application is further configured to process the sharing status of the electronic document to select a graphic from among a plurality of graphics as the indicator for the sharing status.

12. The article of manufacture of claim 10, wherein the application is further configured to process the co-authoring status of the electronic document to select a graphic from among a plurality of graphics as the indicator for the co-authoring status.

13. The article of manufacture of claim 8, wherein the application is further configured to process the co-authoring status to compute a number of end users currently accessing the electronic document, wherein the application is further configured to identify an end user accessing the electronic document from a plurality of end user computers, and, in response to identifying an end user accessing the electronic document from a plurality of end user computers, to count the end user as a single co-author.

14. The article of manufacture of claim 8, wherein the application is further configured to interactively update the graphical element in the graphical user interface for the electronic document currently accessed by the application while the electronic document is accessed by the application.

15. A computer-implemented process comprising:
accessing a shared storage system to retrieve an electronic document, the shared storage system comprising a file system configured to store a plurality of electronic documents and to make the plurality of electronic documents available to a plurality of end user computers over a computer network, the shared storage system further comprising a collaboration system configured to manage coauthoring of an electronic document in the file system by a plurality of end user computers over a computer network;
receiving sharing status of the electronic document from the file system;
receiving co-authoring status of the electronic document from the collaboration system;
displaying a graphical user interface with the electronic document and including a graphical element representing the sharing status and the co-authoring status of the electronic document.

16. The computer-implemented process of claim 15, wherein the graphical element comprises a plurality of different forms, such that each different form represents a different combination of the current sharing status and current co-authoring status of the electronic document currently being displayed through the graphical user interface of the application.

17. The computer-implemented process of claim 15, wherein the graphical element comprises a primary graphic, an indicator of the sharing status and an indicator of the co-authoring status.

18. The computer-implemented process of claim 15, further comprising processing the co-authoring status to compute a number of end users currently accessing the electronic document, wherein the application is further configured to identify an end user accessing the electronic document from a plurality of end user computers, and, in response to identifying an end user accessing the electronic document from a plurality of end user computers, to count the end user as a single co-author.

19. The computer-implemented process of claim 15, further comprising updating, while the electronic document is accessed by the application, the graphical element in the graphical user interface based on changes to at least one of the sharing status or the co-authoring status.

20. The computer-implemented process of claim 15, further comprising, in response to an input indicative of a manipulation of the graphical element by the end user, displaying through the graphical user interface information about the sharing and co-authoring of the electronic document.
